(19) United States
(12) Patent Application Publication
(10) Pub. No.: US 2021/0223778 A1
(43) Pub. Date: Jul. 22, 2021

(54) OBSTACLE DETECTOR FOR CONSTRUCTION VEHICLE

(71) Applicant: SAKAI HEAVY INDUSTRIES, LTD., Tokyo (JP)

(72) Inventor: Ryohei ENDO, Saitama (JP)

(21) Appl. No.: 17/058,123

(22) PCT Filed: May 7, 2019
(86) PCT No.: PCT/JP2019/018218

§ 371 Date: Nov. 23, 2020

(30) Foreign Application Priority Data
May 23, 2018 (JP) 2018-098646

(51) Int. Cl. G05D 1/02; G01S 17/894; G06K 9/00

(52) U.S. Cl. CPC G05D 1/0212; G05D 2201/0202; G06K 9/00805; G01S 17/894

(57) ABSTRACT

An obstacle detector mounted on a construction vehicle includes a TOF-based distance image sensor which is capable of measuring a coordinate of an obstacle based on a time difference between projected light and reflected light, and a controller which determines presence or absence of an obstacle based on coordinate data measured by the distance image sensor and reflection intensity of the reflected light. The controller does not determine an object as an obstacle, when the reflection intensity is equal to or less than a threshold.

### TECHNICAL FIELD

The present invention relates to an obstacle detector for a construction vehicle.

### BACKGROUND ART

When a compactor compacts portions of a road which are very close to a curb, for example, an operator drives while paying attention to a surface to be compacted near the curb, and tends to be careless to portions in a moving direction. Therefore, especially when a vehicle moves backward, an accident is likely to occur to hit workers around the vehicle.

To solve the problem described above, there has been an alarm device or an automatic stop device which uses radio waves or ultrasonic waves, and, when a human or an object is detected within a certain distance, the former gives an alarm and the latter automatically stops the vehicle (See Patent Literatures 1 to 3, for example). Patent Literature 1 discloses an emergency stop device including a magnetic field generator mounted on a vehicle, an IC tag attached to a worker, a detector to detect a radio wave transmitted by the IC tag, and an engine stop device to stop the vehicle when the detector detects the radio wave. Patent Literature 2 discloses a stop system including a trigger signal output unit mounted on a vehicle, an ID tag attached to a worker, a receiver to receive an ID number outputted by the ID tag, and a stop unit to stop the vehicle when the receiver receives the ID number. Patent Literature 3 discloses an ultrasonic obstacle detector.

### CITATION LIST

### Patent Literature

Patent Literature 1: Japanese Patent Application Publication No. 2016-153558

Patent Literature 2: Japanese Patent Application Publication No. 2017-10483

Patent Literature 3: Japanese Patent Application Publication No. 2006-17496

### SUMMARY OF THE INVENTION

### Problems to be Solved

The techniques described in Patent Literatures 1 and 2 require the worker to attach an ID tag. When there are a large number of workers, each of them needs to have an ID tag so that the cost is likely to increase. Further, workers may forget to attach a tag.

Further, when it is foggy or rainy or when water vapor or dust is floating in a construction site, these may also be recognized as obstacles, to have a problem that the alarm is frequently given or the vehicle stops even if there is no possibility of obstacles.

The present invention is provided to solve the problems described above, and an object of the present invention is to provide an obstacle detector for a construction vehicle to reduce false detection of water vapor or dust as an obstacle and to have superior accuracy of detecting an obstacle.

### Solution to Problem

To solve the problem described above, the present invention provides an obstacle detector mounted on a construction vehicle, including: a TOF-based distance image sensor which is capable of measuring a coordinate of an obstacle based on a time difference between projected light and reflected light, and a controller which determines presence or absence of an obstacle based on coordinate data measured by the distance image sensor and reflection intensity of the reflected light.

The present invention uses the TOF-based distance image sensor to enhance accuracy of detecting an obstacle. An operator does not need to have a tag. Further, reflection intensity of reflected light from water vapor or dust has a characteristic of having lower reflection intensity than that of reflected light from a solid object. Therefore, the controller, which determines presence or absence of an obstacle based on the coordinate data measured by the distance image sensor and the reflection intensity of the reflected light, reduces false determination of fine particles, such as water vapor or dust floating in the air, as obstacles.

Further, in the present invention, the controller does not determine the fine particles as obstacles when the reflection intensity is equal to or less than a threshold.

The present invention reduces false determination of the fine particles as obstacles with a simple structure by setting the threshold to an appropriate value.

Further, in the present invention, the threshold is a value based on reflection intensity of reflected light from the ground.

The reflection intensity of the reflected light from the fine particles is approximately equal to or less than the reflection intensity of the reflected light from the ground in most cases. When the threshold is set to a value based on the reflection intensity of the reflected light from the ground, false determination of the fine particles as obstacles is further reduced.

### Advantageous Effects of the Invention

The present invention provides an obstacle detector to reduce false detection of water vapor or dust as an obstacle and have superior accuracy of detecting an obstacle.

### BRIEF DESCRIPTION OF THE DRAWINGS

FIG. 1A is a plan view, and FIG. 1B is a side view, of a detection range of an obstacle detector mounted on a tire roller;

FIG. 2A is a side view of the detection range when any obstacle is not present, and FIG. 2B is a graph showing relationships of Z to X and reflection intensity to X in this case;

FIG. 3A is a side view of the detection range when an obstacle is present, and FIG. 3B is a graph showing the relationships of Z to X and reflection intensity to X in this case;

FIG. 4A is a side view of the detection range when fine particles are present, and FIG. 4B is a graph showing the relationships of Z to X and reflection intensity to X in this case;

FIG. 5 is a perspective view of an experimental example of the obstacle detector;

FIG. 6A is a graph of data of reflection intensity before correction, and FIG. 6B is a graph of data of the reflection intensity after correction, each showing a relationship of reflection intensity to X measured in the experimental example in FIG. 5;

FIG. 7A is a graph of data of the reflection intensity before correction, and FIG. 7B is a graph of data of the reflection intensity after correction, each showing a relationship of Z to X measured in the experimental example in FIG. 5;

FIG. 8A is a graph of data of the reflection intensity before correction, and FIG. 8B is a graph of data of the reflection intensity after correction, each showing a relationship of Z to Y measured in the experimental example in FIG. 5;

FIG. 9A is a graph of data of the reflection intensity before correction, and FIG. 9B is a graph of data of the reflection intensity after correction, each showing a relationship of X to Y measured in the experimental example in FIG. 5; and

FIG. 10 is a flowchart showing an example flow of determining an obstacle according to the present invention.

### EMBODIMENTS OF THE INVENTION

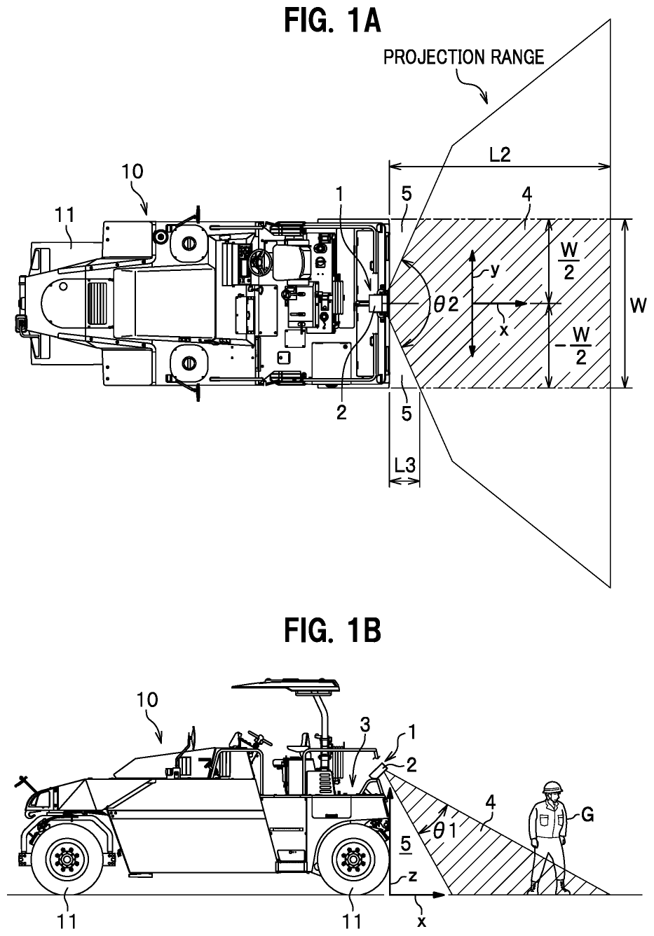

As shown FIG. 1, an obstacle detector 1 of the present invention is mounted on a construction vehicle such as a compactor which moves at a low speed for working. FIG. 1 shows the obstacle detector 1 mounted on a tire roller 10 which compacts an asphalt road or the like by a tire 11. The obstacle detector 1 includes a Time of Flight (TOF-based) distance image sensor (3D distance sensor) 2 capable of measuring coordinates of an obstacle G based on a time difference between projected light and reflected light, and a controller 3.

### [Distance Image Sensor 2]

The distance image sensor 2 includes a light emitter which emits the projected light such as infrared light and a light receiver which receives reflected light when the projected light hits an object. A time since the infrared light has been emitted from the light emitter till the reflected light is received by the light receiver is measured, to measure position coordinates of the object, and accordingly, a distance to the object. An angle of projection from the distance image sensor 2 is a horizontal angle of 95 degrees and a vertical angle of 32 degrees (reference symbol el shown in FIG. 1B), for example, and the projection cross-sectionally has a horizontally long rectangular shape. Image resolution is 64 pixels in the horizontal direction and 16 pixels in the vertical direction, for example, which amounts to a total of 1024 pixels. The distance image sensor 2 is attached to the center in the vehicle lateral (width) direction of a rear of the tire roller 10 to project the projected light obliquely downward in the direction of moving backward.

Concerning a range of detecting the obstacle G, if a range of projecting the projected light is set as the detection range as it is, that is, if a size W in the vehicle width direction is set to be wider than the vehicle width size of the tire roller 10, the obstacle G is recognized to be in the path of the vehicle even though there is no possibility of collision. As a result, the vehicle is stopped unnecessarily. Therefore, the size W of a detection range 4 (indicated by diagonal lines in FIGS. 1A and 1B) in the vehicle width direction is preferably set to be approximately the same as the vehicle width size of the tire roller 10. The distance image sensor 2 can measure the distance to the obstacle G, to allow the controller 3 to determine whether the obstacle G is present within the detection range 4 set to the vehicle width size, based on measurement data for each pixel, more specifically y-data to be described below. The distance image sensor 2 is used as described above so that the size W of the detection range 4 is kept constant in the vehicle longitudinal direction. That is, the detection range 4 can be easily set to have a substantially rectangular range having one side of the size W, in planar view shown in FIG. 1A. A size L2 in the vehicle longitudinal direction of the detection range 4 is appropriately set based on a normal moving speed and is set to about 3 meters in the present embodiment, for example.

Further, the projected light from the distance image sensor 2 is projected obliquely downward in the direction of moving backward, and thus, a lateral angle θ2 of the projected light in planar view is larger range than 95 degrees. Therefore, non-detection ranges 5 defined between both ends of the rear of the tire roller 10 and the detection range 4 have a reduced distance L3 in the vehicle longitudinal direction. That is, non-detected blind ranges defined on both sides of the rear of the vehicle are reduced.

### [Controller 3]

The controller 3 determines presence or absence of the obstacle G based on coordinate data measured by the distance image sensor 2 and the reflection intensity of the reflected light. In FIG. 1, the controller 3 is mounted in the vicinity of the distance image sensor 2 or a driver's seat, for example. The controller 3 calculates coordinate data, including X-data as components in the direction of moving backward from the rear end of the vehicle, Y-data as components in the vehicle width direction from the center in the vehicle width direction, and Z-data as components in the height direction from the ground, based on the measurement data of each pixel measured by the distance image sensor 2, respectively.

Objects which can be detected by the distance image sensor 2 include water vapor or dust, in addition to humans or objects which impede the vehicle from moving. In a compaction process of an asphalt road by a compactor, in order to prevent asphalt mixtures from adhering to a compaction wheel such as a tire, the compactor often compacts the road while an asphalt adhesion preventive agent or water is being sprayed over the compaction wheel. These liquid agents may generate water vapor when coming in contact with an asphalt road or a tire surface in high temperature. Further, in a compaction process of a soil ground, dust may rise from the ground. It is not preferable, in terms of work efficiency, that such water vapor or dust be detected as obstacles.

To solve the problem described above, the present inventors have focused on the reflection intensity of the reflected light to improve accuracy of determining the obstacle G by adding a function of correcting the reflection intensity. The reflection intensity of the reflected light varies depending on a distance to an object, a shape, a material, a color tone, or the like of the object. The reflection intensity from water vapor or dust is lower than that from a human or a solid object. The present inventors made an analysis as follows, focusing on the reflected light especially from the ground.

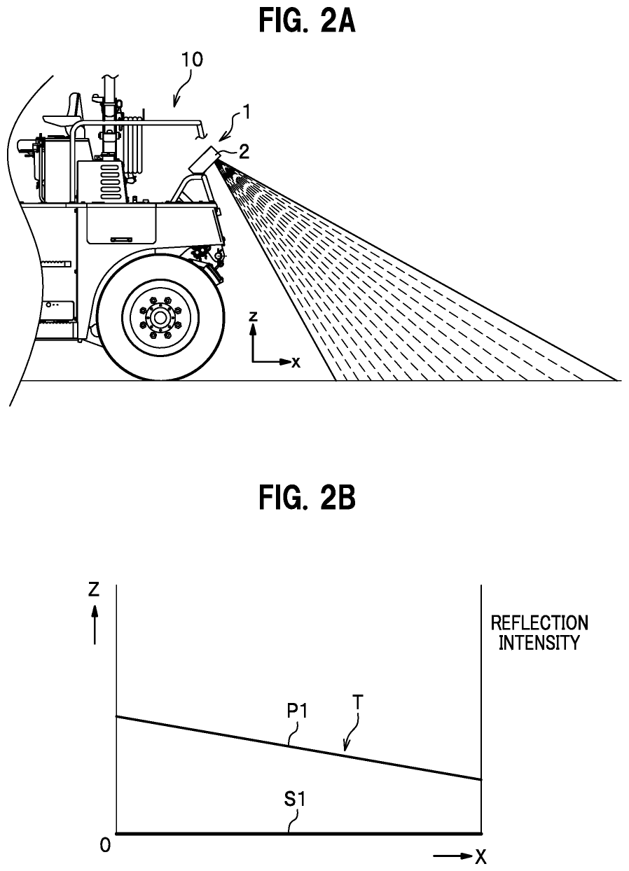

As shown in FIG. 2A, when an obstacle is not present within a measurement range of the distance image sensor 2, the coordinate data to be measured is all related to the ground. In this case, as shown in FIG. 2B, a graph S1 showing a relationship of Z to X indicates that the Z-data, that is, the components in the height direction are 0 over all the X-data, to indicate that there is no obstacle. Meanwhile, the reflection intensity of the reflected light tends to decrease with the increasing distance from the distance image sensor 2 to a measured point. Therefore, a graph P1 showing a relationship of reflection intensity to X indicates that the reflection intensity of the reflected light from the ground decreases with the increasing X-data, that is, with the increasing distance from the vehicle.

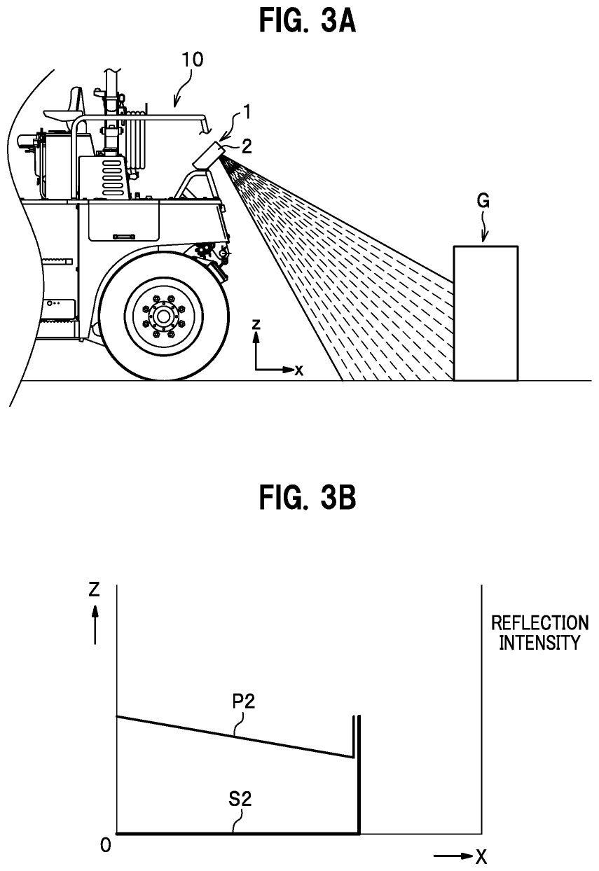

As shown in FIG. 3A, when the obstacle G is present within the measurement range of the distance image sensor 2, a graph S2 showing a relationship of Z to X indicates that the Z-data varies depending on the measured point of the obstacle G, as shown in FIG. 3B. This indicates that the obstacle G is present. A graph P2 showing the relationship of reflection intensity to X generally indicates that the reflection intensity of the reflected light from the obstacle G has a higher value than that from the original ground, though depending on the color tone of the obstacle G.

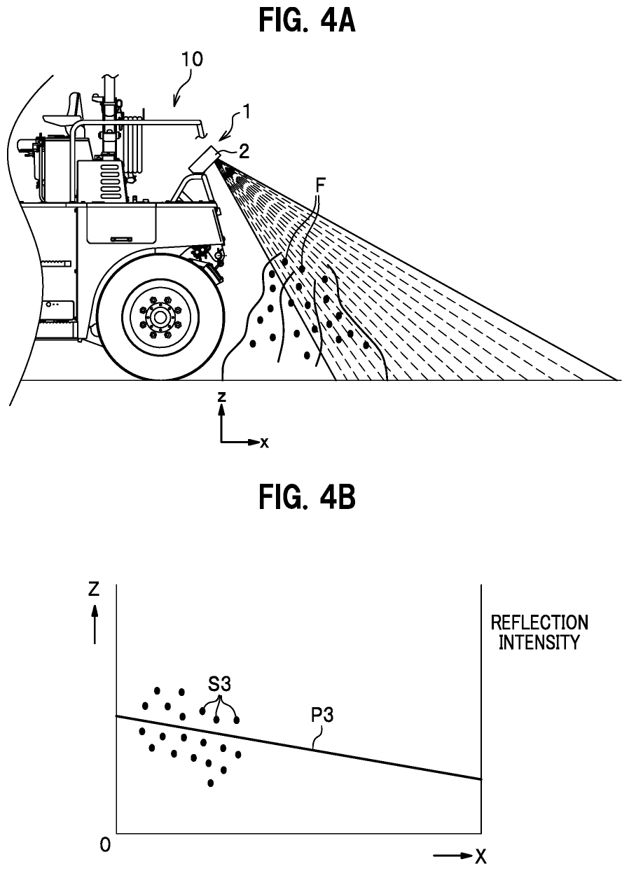

When fine particles F such as water vapor or dust are floating within the measurement range of the distance image sensor 2, as shown in FIG. 4A, the relationship of Z to X is indicated as plots S3 generally scattered at random, as shown in FIG. 4B. Depending on a distribution state of the plots S3, water vapor, dust, or the like may be determined as an obstacle. Meanwhile, the relationship of reflection intensity to X has low reflection intensity of the reflected light from the water vapor or dust. Therefore, a graph P3 is turned out to have approximately the same reflection intensity as the graph P1 in FIG. 2B or lower reflection intensity than that of the graph P1. Accordingly, the reflection intensity of the graph P1 in FIG. 2B, that is, the reflection intensity of the reflected light from the ground may be set as a threshold T, and in a case where the reflection intensity of the reflected light from objects is equal to or less than the threshold T, the controller 3 may assume the objects as the floating fine particles F and not determine as the obstacles G. This improves accuracy of determining the obstacle G.

The threshold T may be a constant obtained in advance through simulation or the like referred to as a fixed value pattern, or a variable obtained by calculating the reflection intensity of the reflected light from the ground in real time during actual operation, referred to as a variable value pattern. In the variable value pattern of the latter case, the threshold T is dynamically determined in real time based on the material or color tone of the road actually compacted so that the accuracy of the threshold T is increased. This further improves accuracy of a cancelling function to exclude water vapor or dust from the obstacle G. As a result, the accuracy of detecting an obstacle is improved. Further, the fixed value pattern and variable value pattern may be manually switched by an operator, or may be determined and switched automatically by the controller 3.

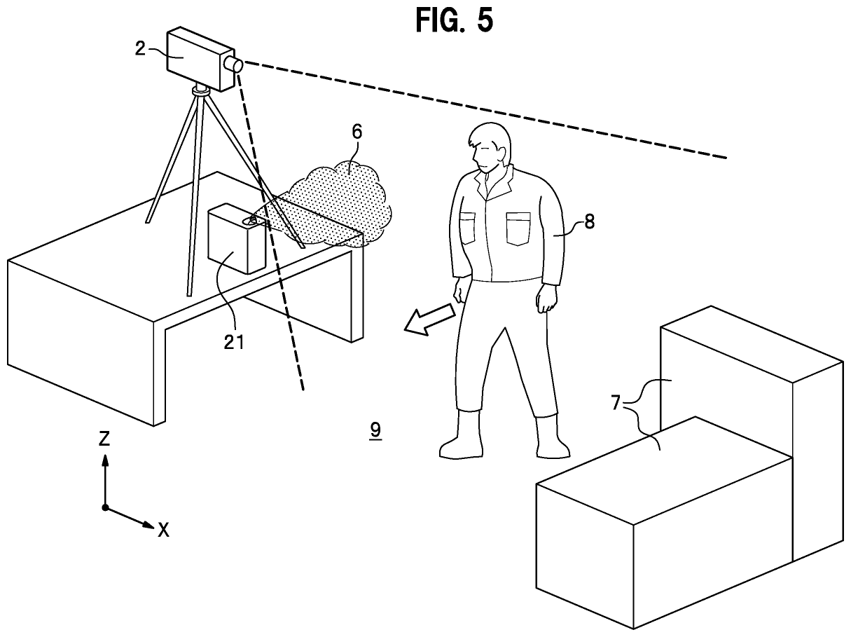

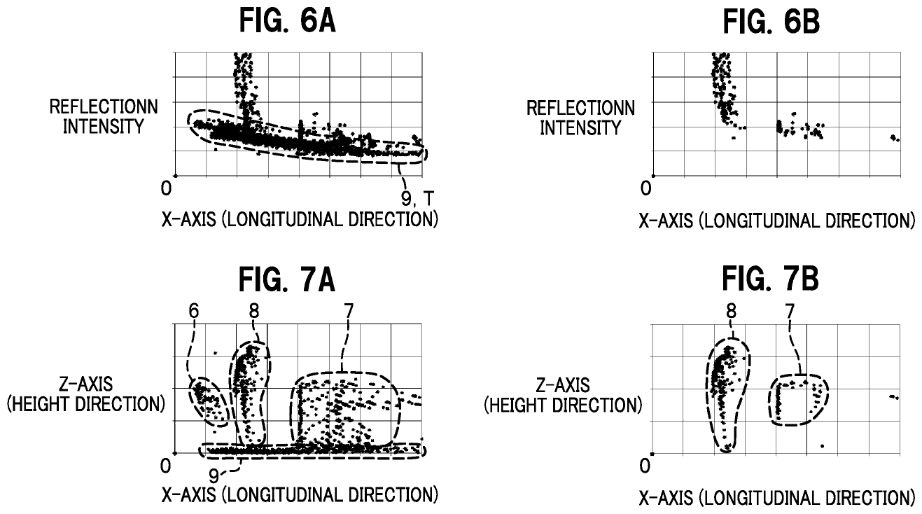

As shown in FIG. 5 as an experimental example, the present inventors measured water vapor 6 ejected from the humidifier 21, a desk 7, a human 8, and a ground 9 with use of the distance image sensor 2. FIGS. 6A to 9B show measurement data. FIGS. 6A and 6B are graphs of the reflection intensity to X, in which FIG. 6A shows the reflection intensity which is not corrected at all, and a portion circled by a dotted line indicates the measurement data of the ground 9. FIG. 6B is a graph in which the measurement data of the ground 9 is set as the threshold T and only the measurement data of the reflection intensity, which is higher than the threshold T, is shown. The threshold T is a value obtained by addition of a standard deviation σ to a value obtained by the least squares of the measurement data or the like, where the standard deviation σ is preferably set to 1.5σ to 3σ.

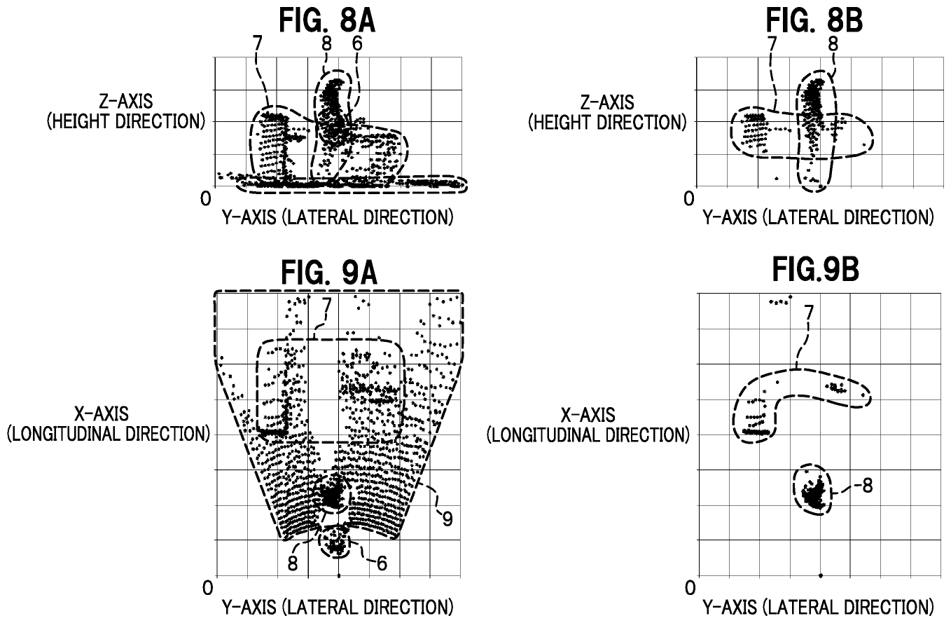

FIGS. 7A to 9B are graphs of Z to X, Z to Y, and X to Y, respectively. FIGS. 7A, 8A, and 9A are graphs when the reflection intensity is not corrected, and FIGS. 7B, 8B, and 9B are graphs when the reflection intensity is corrected with the threshold T. In each of FIG. 7A, FIG. 8A, and FIG. 9A, the measurement data of the water vapor 6, the desk 7, the human 8, and the ground 9 are shown. On the other hand, in FIG. 7B, FIG. 8B, and FIG. 9B after the correction with the threshold T, only the measurement data of the desk 7 and human 8 is shown, and the measurement data of the water vapor 6 and ground 9 is canceled. An obstacle to be detected for the construction vehicle is an object having a certain height such as the desk 7 and human 8 so that there is no problem even the measurement data of the ground 9 is canceled by the correction with the threshold T.

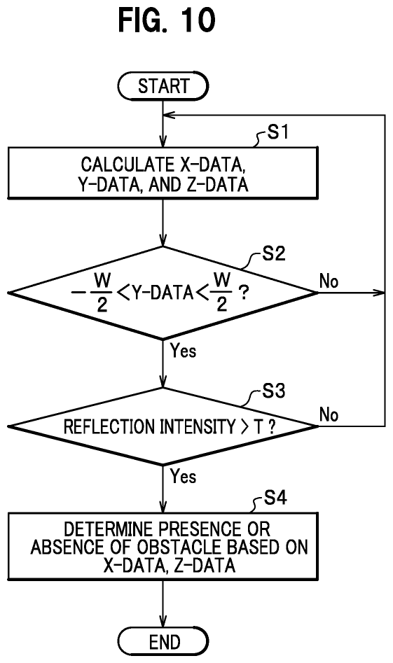

FIG. 10 shows an example flow of determining an obstacle. The controller 3 calculates X-data, Y-data, and Z-data based on the measurement data of each pixel measured by the distance image sensor 2, respectively (step S1) to determine whether the Y-data falls within a range between −W/2 to W/2 with respect to the size W of the detection range 4 (step S2). If it is true, it is determined that the obstacle G may present within the detection range 4, and the processing proceeds to step S3. If it is not true, the process returns to step S1.

In step S3, the controller 3 determines whether the reflection intensity of the measurement data of each pixel is higher than the threshold T. If it is true, the processing proceeds to step S4. If it is not true, the processing returns to step S1. In step S4, the controller 3 determines the presence or absence of an obstacle based on the x-data and the z-data.

As described above, with the controller 3 which determines the presence or absence of the obstacle G based on the coordinate data measured by the distance image sensor 2 and the reflection intensity of the reflected light, false determination of the fine particles F floating in the air, such as water vapor or dust as the obstacles G, is reduced. This reduces unnecessary obstacle detection.

Further, with the controller 3 which does not determine the objects as the obstacles G, if the reflection intensity is equal to or less than the threshold T, false determination of the fine particles F as the obstacle G is reduced with a simple configuration, that is, by setting the threshold T to an appropriate value.

The reflection intensity of the reflected light from the fine particles F is approximately equal to or less than that from the ground in most cases, and thus the threshold T is set to a value based on the reflection intensity of the reflected light from the ground so that false determination of the fine particles F as the obstacles G is further reduced. False determination due to irregularities of the ground is also prevented by correcting the reflection intensity so that it is not necessary to determine presence or absence of an obstacle by separately filtering Z-data.

The preferred embodiment of the present invention is described above. In the embodiment described above, the distance image sensor 2 is attached to the rear of the vehicle, but may be attached to a front of the vehicle to detect obstacles in the direction of the vehicle moving forward.

### REFERENCE NUMERALS

1: obstacle detector, 2: distance image sensor, 3: controller, 4: detection range, 5: non-detection range, 10: tire roller (construction vehicle)

1. An obstacle detector mounted on a construction vehicle, comprising:
a TOF-based distance image sensor which is capable of measuring a coordinate of an obstacle based on a time difference between projected light and reflected light; and
a controller which determines presence or absence of an obstacle based on coordinate data measured by the distance image sensor and reflection intensity of the reflected light.

2. The obstacle detector for a construction vehicle as claimed in claim 1, wherein, when the reflection intensity is equal to or less than a threshold, the controller does not determine an object as an obstacle.

3. The obstacle detector for a construction vehicle as claimed in claim 2, wherein the threshold is a value based on reflection intensity of the reflected light from a ground.

4. The obstacle detector for a construction vehicle as claimed in claim 3, wherein the construction vehicle is a compactor, and the ground is an asphalt road.
